(19) United States
(12) Patent Application Publication
(10) Pub. No.: US 2013/0297624 A1
(43) Pub. Date: Nov. 7, 2013

(54) Interoperability between Map-Reduce and Distributed Array Runtimes

(71) Applicants: Sudarshan Raghunathan, Cambridge, MA (US); Damon Robert Hachmeister, North Grafton, MA (US)

(72) Inventors: Sudarshan Raghunathan, Cambridge, MA (US); Damon Robert Hachmeister, North Grafton, MA (US)

(73) Assignee: MICROSOFT CORPORATION, Redmond, WA (US)

(21) Appl. No.: 13/465,394

(22) Filed: May 7, 2012

(51) Int. Cl. G06F 17/30

(52) U.S. Cl. 707/752; 707/E17.032; 707/E17.01

(57) ABSTRACT

Described is a technology by which Map-Reduce runtimes and distributed array runtimes are interoperable. Map-Reduce chunks are processed into array data for processing in a distributed array runtime based upon merge information. A staging Map-Reduce job tags a chunk with tag information that indicates a relative position of the chunk in an array. A distributed array framework imports files produced via a Map-Reduce framework and provides an array to an application of the distributed array framework for processing. An export mechanism may output one or more Map-Reduce files from the distributed array framework.

### BACKGROUND

Map-Reduce (sometimes spelled MapReduce or Map/Reduce) runtimes such as Hadoop™ provide programming models used for transforming data in the form of (key, value) pairs into a resulting set of data. In general, Map-Reduce operates by using a map function to transform the (key, value) pairs into intermediate data, with the intermediate data in turn processed by a reduce function to provide the resulting data set. As an example, a user may use a Map-Reduce runtime to process a large corpus of documents and only extract those documents that meet a specified criterion, or process those documents into numerical data such as numerical counts of each of the words therein. The map function may be run in parallel to scale to large amounts of data, as may the reduce function, and multiple Map-Reduce transformation iterations/operations may occur.

Map-Reduce runtimes are appropriate for performing simple data transformation operations in a scalable manner on large data sets using commodity (e.g., low-cost) computing hardware. Typically, after a number of such Map-Reduce transformations, the resulting data set is much smaller than the original data set, although the resulting data set may still be relatively large. With the resulting data set, the user may then perform more complex data analyses on the data, such as finding out the coefficients of correlation between a set of documents.

However, the Map-Reduce programming model is not necessarily optimal for expressing complex mathematical operations such as matrix multiplication and decompositions that are often used to extract meaningful information from large amounts of data. Therefore, a user desiring one or more such complex operations has to either rewrite his or her algorithms in a Map-Reduce model or further extract only a subset of the data that is small enough to analyze on his or her computing machine. Using such an extracted subset may result in useful information being lost.

In contrast to Map-Reduce runtimes, a distributed array runtime, e.g., one that exposes the concept of partitioned arrays and is built on top of a high-performance message-passing framework such as MPI (Message Passing Interface), is more appropriate for performing complex array operations on large data, provided the data is able to fit in the memory among the nodes in the cluster on which it is running. Note that typically the multiple nodes in such a cluster provide a much larger amount of memory than a commodity computing machine. However, distributed-computing runtimes are not particularly well suited for the simple data transformations that are done within a Map-Reduce framework. While many types of data processing tasks may benefit from both Map-Reduce and distributed array runtimes, there is heretofore no known way to transfer data between them efficiently in a manner that effectively leverages the advantages of both runtimes.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which Map-Reduce chunks are processed into array data for processing in a distributed array runtime. One or more files containing the chunks are accessed, in which the chunks are sorted by array position information. The chunks are assembled into the array data based upon merge information.

In one aspect, a staging Map-Reduce job is executed, including performing a staging mapping operation that tags a chunk with tag information that indicates a relative position of the chunk in an array. The chunks may comprise row vectors, column vectors or hyperplanes (slices of a multi-dimensional array), and may be sorted based upon row position, column or hyperplane position information, respectively.

In one aspect, a distributed array framework accesses files produced via a Map-Reduce framework, in which the files contain Map-Reduce chunks sorted based upon array position information. An import mechanism converts data in the files containing the chunks into a data structure corresponding to an array containing array dimension information and array data. The array may be processed by an application of the distributed array framework. An export mechanism may output one or more Map-Reduce files from the distributed array framework.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a system configured to provide interoperability between a Map-Reduce runtime and a distributed array runtime.

FIG. 2 is a dataflow/flow diagram showing various example steps as data is communicated and processed between a Map-Reduce runtime and a distributed array runtime.

FIG. 3 is a representation of a data structure containing Map-Reduce output data arranged as records.

FIG. 4 is representation of a data structure containing array-related data corresponding to Map-Reduce output data.

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards a technology by which Map-Reduce and distributed array runtimes complement each other to accomplish data processing tasks, via a unified solution that allows a user to efficiently switch from one to the other as desired. To this end, the technology provides for efficiently interoperating between a Map-Reduce runtime and a distributed array runtime based upon the two distinct runtimes interchanging portions of distributed arrays.

As described herein, a “staging” Map-Reduce job is run to produce a set of formatted files containing portions/chunks of a distributed array. As part of the mapping, the data is associated with a tag that indicates each chunk's relative position with respect to other chunks in an array. As will be understood, the properties of the Map-Reduce infrastructure aggregate chunks that are spatially adjacent, whereby they can be input efficiently into a distributed array runtime, e.g., with minimal post-processing. As also described herein, after processing in the distributed array runtime, the distributed array runtime is capable of outputting a collection of output files that appear to have come from any other job in the Map-Reduce runtime, and can therefore be ingested by a subsequent Map-Reduce job for further processing.

It should be understood that any of the examples herein are non-limiting. For example, example data structures are described herein, however other data structures may be similarly used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

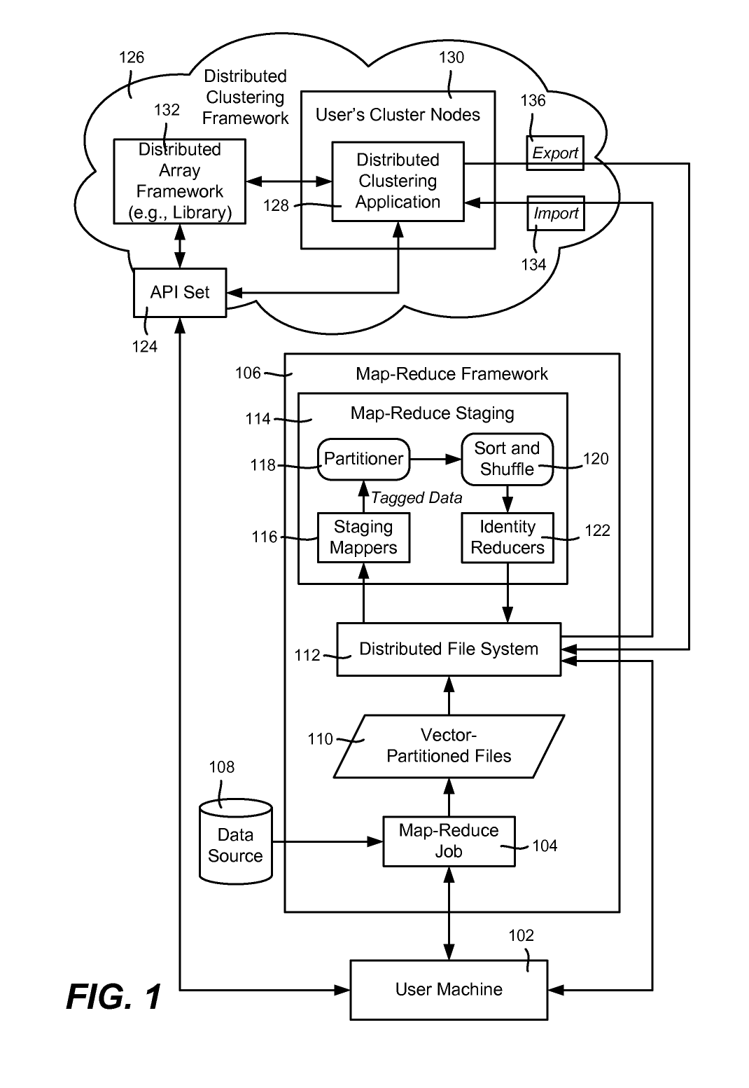

FIG. 1 shows a block diagram comprising various example components related to interoperability between Map-Reduce and distributed array runtimes. As shown in FIG. 1, a user machine 102 runs a user-provided Map-Reduce job 104 on a Map-Reduce framework 106 to process some set of data, as represented by data source 108. Note that the some or all of the Map-Reduce framework 106 may exist locally on the user machine 102, or may be on a remote machine or set of machines to which the user machine 102 is coupled. For example, the user may have access to a node cluster for running such programs as desired.

In the example of FIG. 1, the output of the map reduce job comprises a set of files 110, e.g., in a conventional Map-Reduce output format written to a storage, exemplified herein as a distributed file system 112; for example, the distributed File System (e.g., of Hadoop™) comprises a replicated, partitioned data store underlying most of the distributed operations of the Map-Reduce runtime. Further note that these files may be iteratively processed by more than one Map-Reduce job until a desired state of Map-Reduce results is obtained.

As also represented in FIG. 1 and as described below, the files are further processed by a Map-Reduce staging mechanism/phase 114, comprising Map-Reduce staging mappers 116, a partitioner mechanism 118, a sort-and-shuffle mechanism 120 and reducers (shown as identity reducers 122, although more complex reducers may be used). Because many types of data are able to be processed, the user provides (e.g., writes or specifies parameters to a tool that generates the staging mapper code) such a staging mapper for running in parallel as the staging mappers 116.

As described herein, the staging mappers 116 tag each key-value pair with relative array position information, e.g., where that set of data is to be positioned in an array (that will be processed by the distributed clustering framework) relative to other data in the array. Partitioning by the partitioner mechanism 118 determines which reducers receive the output, which is sorted and arranged for efficiency by the sort-and-shuffle mechanism 120; at least some of these operations may be performed in parallel. Note that identity reducers 122 do not process the data further, although it is feasible to have some processing performed by a different set of reducers in the Map-Reduce staging phase 114. The output from the reducers 122 comprises the arranged data in conventionally formatted Map-Reduce output files in the distributed file system 112.

In general, a user who has existing data in a file-system 112 used by the Map-Reduce framework 106 provides a description of how the data is to be transformed into a distributed array. For example, in a document processing application, the element (i,j) of the array may correspond to the number of times the term j occurs in document i. Instead of specifying the elements of the array one at a time, the user typically describes a collection or chunk of elements in the array along with its index relative to other chunks of the array. For example, a chunk may correspond to a single row of a matrix and the relative index can be the row number. This specification is performed as part of a “Map” step (the staging mappers 116) in the staging Map-Reduce job.

In addition, the user specifies a partitioning strategy that determines how chunks are grouped together and assigned to the individual reducers 122 (basically to determine what chunks are written to which file, which may be via a specified hash function or another function). When the staging Map-Reduce job executes, the chunks that belong to the same file are collected and written out in sorted order into a predetermined number of (e.g., R) files.

Turning to distributed clustering operations, via an API set 124 or the like that interfaces to the distributed clustering framework 126, the user machine 102 may communicate information such as the location in the distributed file system 112 of the files to be processed, and identify or provide a distributed clustering application 128 to run on user cluster nodes 130. The application 128 may correspond to one or more functions to use to process the file data and so forth, such as provided in an existing library of array processing functions, e.g., a distributed array framework 132 (such as a distributed array runtime built on top of the MPI message-passing library) including numeric matrix processing functions. As described herein, an import function 134 imports the arranged data files from the distributed file system 112 in a format (e.g., into an array) that is appropriate for the distributed clustering application 128/distributed array framework 132 to efficiently consume.

In general, the user runs a function provided by the distributed array runtime and specifies a “merge” strategy that determines how the partitioned chunks are laminated into a distributed array. The distributed runtime runs on P processes (also referred to as ranks) that collectively read the R outputs produced by the staging Map-Reduce application (in a parallel manner) and uses the merge strategy specified by the user to laminate the partitions together into a distributed array. Because the chunks within a single file are guaranteed to be sorted, they do not have to be reordered among themselves. Moreover, by an appropriate choice of key and partitioner (one that is problem specific) or by using a partitioner (such as the “total order” partitioner provided by Hadoop™) chunks in a file Rᵢ do not have to be ordered with respect to chunks in the file Rⱼ.

A straightforward mechanism for aligning the processes, or ranks, with files may be used. For example, if the number of files is the same as the number of ranks, each rank reads a single file in its entirety. If the number of files is larger than the number of ranks, each rank is assigned to read none, one or more files. If the number of files is less than the number of ranks, each rank reads a part of a single file.

Note that the process can be reversed, in that the distributed array framework 126 can produce a collection of R files that can be processed by the Map-Reduce framework 106. To this end, following processing, an export function 136 may be used to write the results back to the distributed file system 112. As described herein, the format of the export function may comprise one or more conventional Map-Reduce files, which may be processed by any subsequent Map-Reduce programs as desired. Thus, the Map-Reduce staging phase 114, along with the import and export functions 134 and 136, respectively, provide an efficient and seamless way for transitioning between a Map-Reduce framework and a distributed clustering framework.

By way of a practical example, consider a user with a collection of raw XML files who wants to perform cluster analysis on pertinent data corresponding to only some of the (e.g., numerical) fields in the data. In this example, the pertinent data is large enough that it does not fit into the user's workstation memory, but fits into the memory of a pre-provisioned cloud (e.g., Microsoft® Azure) node cluster.

The user runs a Map-Reduce job to extract the numerical data from the collection of XML files, along with the Map-Reduce staging job as described herein. Note that it is feasible to extract the data and perform the staging in a single Map-Reduce job. In the job or jobs, the “map” tasks, including staging, output as their key the relative array position of the numerical value. The “reduce” tasks aggregate the values for a given key into a row or column vector, as specified by the user (or specified in file metadata). In this example, the output of the Map-Reduce job is therefore a collection of row or column vectors partitioned into r files, where r is the number of reducers, also specified by the user (or in the metadata).

The user implements a distributed clustering application such as the application 128 (e.g., in C# using the distributed array framework 132). The input data to the distributed clustering application is the set of vectors created by the Map-Reduce job. However, as described herein, as a result of partitioning and sorting/shuffling, the input data is arranged according to the relative positions in the array, whereby with minimal post-processing/inter-process communication is needed to provide the distributed array framework 132 with the array to process. Note that alternatively the tagging may be placed in metadata in the Map-Reduce output files, whereby the distributed clustering framework may sort and shuffle to assemble the array (although likely in a far less efficient manner).

In this example, the distributed application 128, which may run on the same set of nodes 130 as the user's cluster, ingests the arranged data from the output of the Map-Reduce job, assembles (e.g., concatenates) the individual matrix chunks into a large distributed array, performs cluster analysis (e.g., via the distributed array framework 132) and writes the results back into the distributed file system 112. The results may appear as the output of any other Map-Reduce job, whereby the user can then feed the data back to another Map-Reduce job. Alternatively, (or in addition to feeding the data to another Map-Reduce job), the user may decide to post-process the resultant data in some other way, e.g., using existing tools developed in the Hadoop™ ecosystem.

It should be noted that FIG. 1 is only an example. For example, some or all of the same physical machines may be used in both of the frameworks 106 and 126. The sharing of the storage mechanism, which in this example comprises the distributed file system 112, provides for any combination of machines and so forth. Further, note that the distributed file system 112 may be external to the map-reduce framework 106 in other implementations.

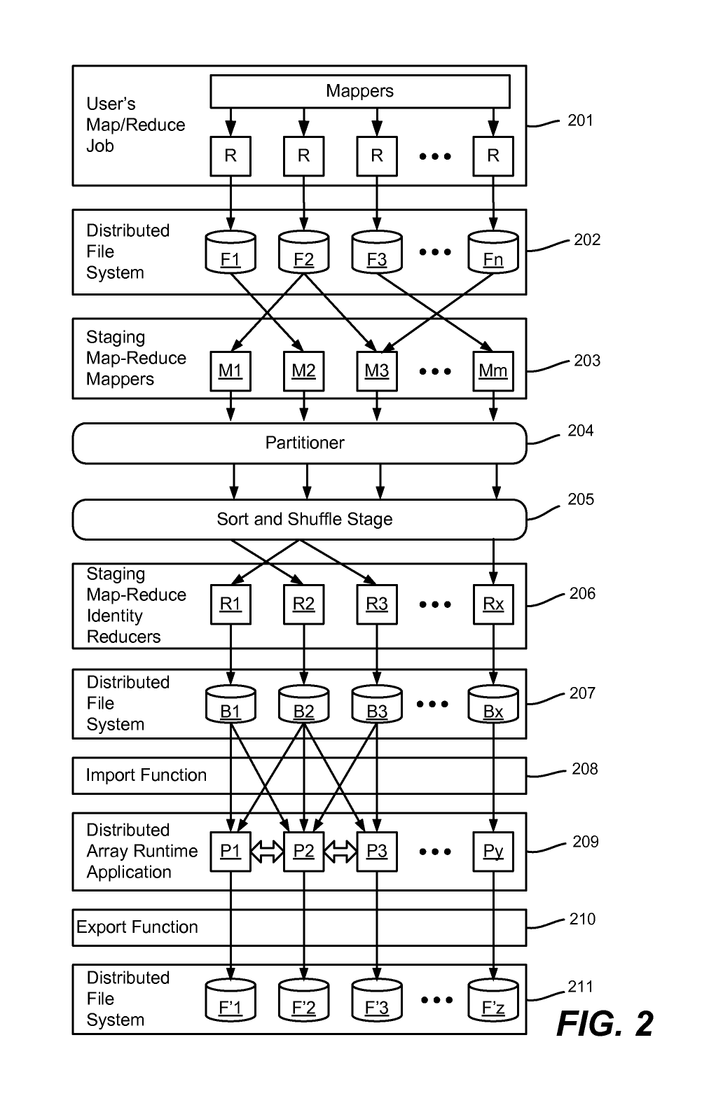

FIG. 2 exemplifies a basic workflow/data flow diagram for interoperating between a Map-Reduce runtime such as the framework 106 and a distributed array runtime (e.g., the framework 126 running a distributed array application 128) using a distributed file system 112 as the storage medium. The user initially starts off with a pre-existing Map-Reduce application (step 201) that generates a set of output files F1-Fn in the distributed file system (step 202).

The output files F1-Fn do not exist in a form that can be directly read in by a distributed array runtime application. The user therefore provides (e.g., writes or provides parameters for) a staging Map-Reduce job, comprising code in which a set of mappers (M1-Mm) ingest the existing data files F1-Fn and emit tagged chunks corresponding to a distributed array (e.g., using a set of custom data types exemplified herein) as represented by step 203. In particular, each of the chunks is “tagged” using application-specific keys that denote the relative position of a chunk in the global distributed array. For example, if the chunks correspond to rows of a distributed array, the tag specifies the relative ordering of the rows. The tag values need not be unique; in fact, specifying the same tag values for multiple chunks guarantees that the values will be adjacent to each other in the resulting distributed array (although the precise ordering of the chunks is not guaranteed without a secondary sort).

Once the tagged array chunks are emitted, a partitioner at step 204 assigns each tagged chunk to a particular reducer R1-Rx as described herein. One example (e.g., default) partitioner that may be chosen by the user uses a hash function to compute the hash value of the tag to distribute chunks among the reducers. Another partitioner may instead be chosen based on the specific application, e.g., partitioner such the “total order” partitioner. Note that as the chosen partitioner assigns tagged chunks to the reducers, the tagging scheme guarantees the total ordering of keys.

Via a sort and shuffle stage (step 205) of the framework, a “group-by” operation is performed that aggregates the keys/tags that are assigned to a given reducer and locally sorts them, such that each reducer receives its keys in sorted order. That is, the sort and shuffle stage (step 206) sorts the input to the reducers R1-Rx by key to move the sorted data to the reducers R1-Rx. At step 207, the reducers R1-Rx (shown collectively as identity reducers) then emit the sorted tagged distributed array chunks as a collection of specifically-formatted binary files B1-Bx in the distributed file system, possibly along with optional metadata.

For example, in Hadoop™, a partitioner is responsible for assigning a given intermediate key-value pair to one of the R reduce tasks. For example, the default partitioner assigns a key K to the reducer hash(K)%R. Similarly, the “total order partitioner” assigns a key to reducer such that if K₁ is less than or equal to K₂, then r₁ is less than or equal to r₂. The sort and shuffle phase guarantees that keys assigned to a particular reducer are seen in a sorted order.

The choice of key and partitioner is problem-specific. For example, for an application that computes only the singular values of a large matrix and generates entire rows or columns at a time, the choice of a particular partitioner is not significant because the singular values of a matrix are invariant to row and column permutations. Conversely, if both the singular values and singular vectors are needed, then a partitioner that guarantees total ordering of the keys needs to be used; note that instead of using the total order partitioner in Hadoop™, a key K to reducer r may be assigned using the default hash partitioner, by setting K=r×Rₘₐₓ+j where Rₘₐₓ is the maximum number of chunks per reducer and j<Rₘₐₓ is a scalar that indicates the relative ordering of the chunks within the reducer r.

An import function at step 208 may read the binary output files B1-Bx directly into the distributed array runtime application 209. In general, the import function creates a distributed array based on the tagged key-value pairs and passes the array into the user's distributed array runtime application (step 209). After the application performs numerical computations (and/or possibly other processing) on the distributed array, the user can choose to export the results at step 210 via an export function as files F′1-F′z into the distributed file system (step 211). The format of the files F′1-F′z may be such that they appear as the output of a Map-Reduce job. This set of output files F′1-F′z can thus be post-processed sequentially, for example, or because it appears as the output of a Map-Reduce job, may be fed as input to yet another Map-Reduce runtime, (or to another distributed array runtime application, using the mechanisms described above).

As can be readily appreciated, the technology described herein provides a mechanism for efficiently composing Map-Reduce runtimes with distributed array runtimes. The technology described herein uses an efficient binary representation of distributed data and is able to read and write files in parallel directly from a storage such as an underlying distributed file system, e.g., without requiring the data to be staged in a different location. Further, the application is able to read the data imported from the output of a prior Map-Reduce job, and the data is able to be exported directly to the distributed file system such that it appears to be the output of a Map-Reduce job. Indeed, a distributed array framework application may appear as a Map-Reduce job and integrate into an existing Map-Reduce based analysis workflow. Note that the application supports the import and export of multi-dimensional numerical arrays.

Turning to aspects of the data interchange in the example of a Hadoop™ Map-Reduce runtime, one data interchange format between the Map-Reduce runtime and the distributed array runtime is based on SequenceFiles. SequenceFiles are flat binary files containing a collection of key-value pairs separated by a unique sync marker. The key and value types implement a Writable interface in Hadoop™, which is the default serialization mechanism.

Note that encoding large distributed arrays of numerical values as text is considerably more inefficient than encoding the values in a binary format such as a SequenceFile. In addition, SequenceFiles support various compression schemes and allow embedded metadata to specify some of or all of the information, such as the type of the underlying array, preferred dimensions of distribution and concatenation (merge information), and so forth. For example, the metadata may specify that the data is to be processed into five-by-five matrices, with as many matrices as needed to handle the data.

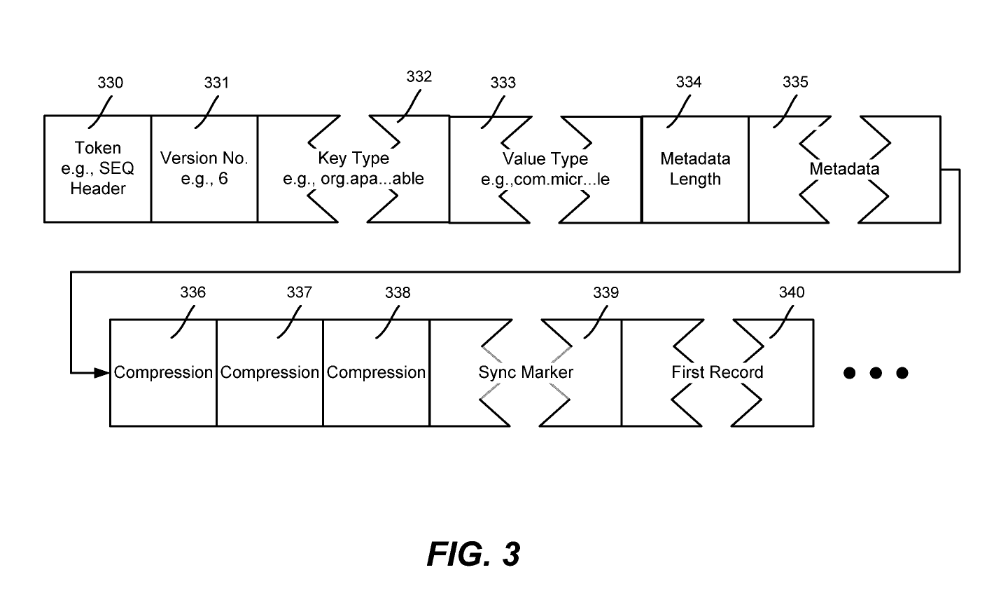

The layout of a one such binary SequenceFile is shown in FIG. 3. In general, one implementation of a SequenceFile comprises a short header including a token 330 and a version number 331, (e.g., this part of the header may comprise four bytes in total). This header information is followed by name of the key 332 and value classes 333 (strings of indeterminate length), and via fields 334 and 335, string-encoded metadata values (a string of specified length). Compression information (e.g., two bytes to indicate block and record compression, followed by the name of the compression codec) is represented via fields 336-338.

A unique sync marker 339 (sixteen bytes in this implementation) is provided. More particularly, following the header is a collection of key and value pairs comprising one or more records 340 encoded according to the serialization specified when implementing the Writable interface. The sync marker 339 is inserted at regular intervals at record boundaries to facilitate reading the SequenceFile in parallel.

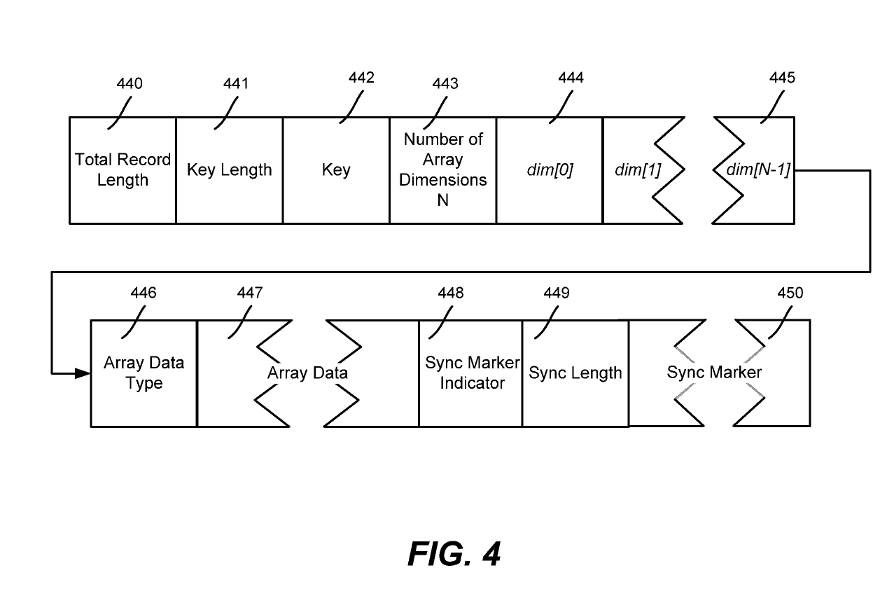

Turning to storing distributed arrays in SequenceFiles, one implementation of a particular SequenceFile format used for encoding chunks of a distributed array is represented in FIG. 4. Blocks shown in the example structure of FIG. 4 including total record length 440, key length 441, key 442, number (N) of array dimensions 443, dim[0] 444 through dim[N−1] 445, array data type 446, and array data 447. The structure supports sync markers, as provided via a sync marker indicator 448, sync marker length 449 and a sync marker 450.

In one implementation, the key comprises a four-byte integer representing the relative location of the array chunk in distributed memory. The value identifies the number of array dimensions, the size along each dimension (e.g., all four-byte integers), a tag describing the element type of the array (one byte) and the array data itself (number of elements size of each element).

As can be seen, there is described the use of a Map-Reduce system to create a collection of tagged distributed array chunks where the tags denote the position of the chunk of the distributed array relative to other chunks. The collection of tagged distributed array chunks is read into distributed array environment, which is able to use the structure of the files produced by the Map-Reduce system to assemble the pieces of the distributed array with a relatively minimal amount of inter-process communication.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

The computers/computing environment typically includes a variety of computer-readable media. Computer-readable media can be any available media that can be accessed by a computer and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

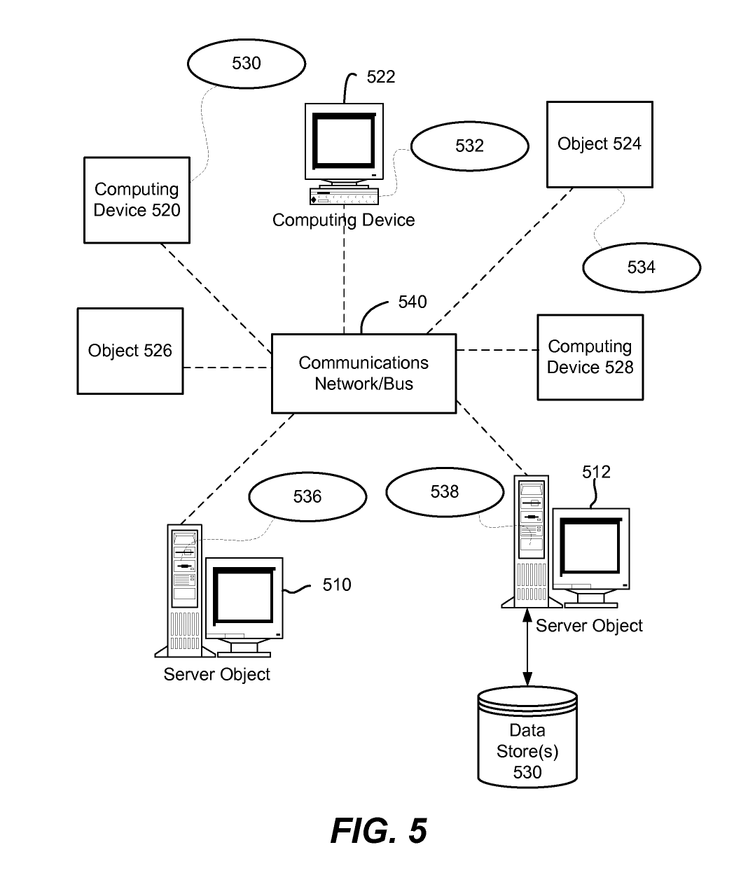

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

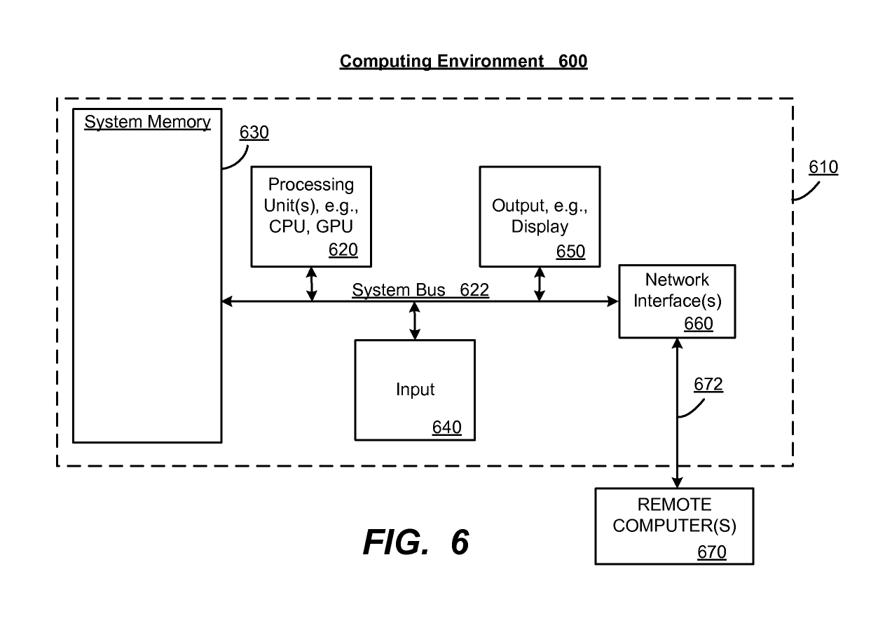

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor comprising, processing Map-Reduce chunks into array data for processing in a distributed array runtime, including accessing one or more files containing the chunks, in which the chunks are sorted by array position information, and assembling the chunks based upon merge information into the array data.

2. The method of claim 1 further comprising, processing the chunks in a staging Map-Reduce job to sort the chunks, including tagging the chunks with relative array position information, partitioning the chunks based upon a number of reducers, sorting the chunks based upon the relative array position information into sorted chunks, and providing the chunks to the reducers based upon the sorting

3. The method of claim 2 further comprising, at each reducer, writing a file to a distributed file system.

4. The method of claim 1 further comprising, exporting results of the processing in a distributed array runtime into one or more Map-Reduce output data files.

5. The method of claim 4 wherein exporting the results comprises writing the one or more Map-Reduce output data files to a distributed file system.

6. The method of claim 1 wherein the chunks correspond to row or columns vectors, and further comprising, sorting the chunks based upon row position information or column position information.

7. The method of claim 1 wherein the chunks correspond to hyperplanes, and further comprising, sorting the chunks based upon hyperplane position information.

8. The method of claim 1 wherein accessing the one or more files comprises reading the files from a distributed file system.

9. The method of claim 1 further comprising, obtaining the merge information from metadata included in the one or more files.

10. A system comprising, a distributed array framework configured to access files produced via a Map-Reduce framework, in which the files contain chunks of a distributed array sorted based upon array position information, and an import mechanism configured to convert data in the files containing the chunks into a data structure corresponding to an array containing array dimension information and array data, for processing of the array by an application of the distributed array framework.

11. The system of claim 10 wherein the import mechanism converts the data into the data structure based upon merge information.

12. The system of claim 10 further comprising a staging mechanism of the map reduce framework, in which the staging mechanism includes one or more mappers that each tags chunks with relative array position information, and a sort mechanism configured to produce one or more of the files sorted based upon the relative position information.

13. The system of claim 12 wherein the staging mechanism further includes a partitioner configured to associate tagged chunks with reducers, in which the sort mechanism determines arranges the chunks for the reducers based upon the relative array position information.

14. The system of claim 10 wherein the distributed array framework includes a distributed array framework library.

15. The system of claim 10 wherein the Map-Reduce framework comprises a Hadoop™-based runtime environment in which the files are accessed via a distributed file system.

16. The system of claim 10 further comprising an export mechanism configured to output one or more Map-Reduce files from the distributed array framework.

17. The system of claim 10 wherein the array comprises a multidimensional numeric array.

18. One or more computer-readable media having computer-executable instructions, which when executed perform steps, comprising, executing a staging Map-Reduce job, including performing a staging mapping operation that tags a chunk with tag information that indicates a relative position of the chunk in an array.

19. The one or more computer-readable media of claim 18 having further computer-executable instructions comprising, sorting a plurality of chunks based upon associated tag information for output as a sorted set of file data in which the ordering of the sorted set of file data is based upon the associated tag information.

20. The one or more computer-readable media of claim 18 having further computer-executable instructions comprising, processing the sorted set of file data into array data, in which the position of each chunk in the array data is based upon the ordering of the sorted set of file data.
